(19) United States
(12) Patent Application Publication
(10) Pub. No.: US 2026/0110209 A1
(43) Pub. Date: Apr. 23, 2026

(54) METHODS AND SYSTEMS TO USE DISPLAYS AND VEHICLE HAPTICS FOR POWER DOOR CONTROLS

(71) Applicant: GM GLOBAL TECHNOLOGY OPERATIONS LLC, Detroit, MI (US)

(72) Inventors: Thiago Laserra Lima, Sterling Heights, MI (US); Sitaram Emani, Novi, MI (US); Carlos S. Jabbour, Shelby Twp., MI (US); Tony Argote, JR., Macomb, MI (US); Mati Goro, Sterling Heights, MI (US)

(73) Assignee: GM GLOBAL TECHNOLOGY OPERATIONS LLC, Detroit, MI (US)

(21) Appl. No.: 18/921,744

(22) Filed: Oct. 21, 2024

(51) Int. Cl. E05F 15/73; E05F 15/40

(52) U.S. Cl. CPC E05F 15/73; E05F 15/40; E05Y 2400/54; E05Y 2400/818; E05Y 2400/86; E05Y 2900/531

(57) ABSTRACT

Methods and systems are providing for controlling opening a door of a vehicle, including detection sensors that obtain detection sensor data as to an object in proximity to the vehicle; input sensors that obtain input sensor data as to a requested opening position for the door; and a processor that determines, using the sensor data, whether the object would interfere with the opening of the door to the requested opening position; automatically opening the door to the requested opening position when it is determined that the object would not interfere with the opening of the door to the requested opening position; and taking corrective action, instead of opening the door to the requested opening position, when it is determined by the processor that the object would interfere with the opening of the door to the requested opening position.

### INTRODUCTION

The technical field generally relates to vehicles and, more specifically, to methods and systems for controlling power doors of vehicles as well as other opening members of vehicles.

Certain vehicles today include power doors that are automatically opened and closed by the vehicle upon receiving input from a user of the vehicle. However, in certain situations exiting methods and systems for controlling power doors may not be optimal, including when an object is in proximity to the vehicle.

Accordingly, it is desirable to provide improved methods and systems for controlling power doors of a vehicle, including when an object is in proximity to the vehicle.

### SUMMARY

In accordance with an exemplary embodiment, a method of controlling opening an opening member of a vehicle is provided that includes obtaining detection sensor data, via one or more detection sensors of the vehicle, as to an object in proximity to the vehicle; obtaining input sensor data, via one or more input sensors of the vehicle, as to a requested opening position for the opening member; determining, via a processor of the vehicle using the detection sensor data and the input sensor data, whether the object would interfere with the opening of the opening member to the requested opening position; automatically opening the opening member to the requested opening position, in accordance with instructions provided by the processor to one or more actuators of the vehicle and that are implemented via the one or more actuators, when it is determined by the processor that the object would not interfere with the opening of the opening member to the requested opening position; and taking corrective action, instead of opening the opening member to the requested opening position, in accordance with instructions provided by the processor, when it is determined by the processor that the object would interfere with the opening of the opening member to the requested opening position.

Also in an exemplary embodiment, the opening member comprises a door of the vehicle.

Also in an exemplary embodiment, the step of obtaining the detection sensor data includes obtaining radar sensor data, via one or more radar sensors of the vehicle, as to the object; and the step of determining whether the object would interfere with the opening the door to the requested opening position includes determining, via the processor using the radar sensor data and the input sensor data, whether the object would interfere with the opening of the door to the requested opening position.

Also in an exemplary embodiment, the step of taking corrective action includes providing a warning to a user of the vehicle, instead of automatically opening the door to the requested opening position, when it is determined by the processor that the object would interfere with the opening of the door to the requested opening position.

Also in an exemplary embodiment, the step of taking corrective action includes providing a visual warning to the user, on a display screen of the vehicle in accordance with instructions provide by the processor, that the door cannot be opened to the requested opening position due to the object that is in a path of the door.

Also in an exemplary embodiment, the step of taking corrective action includes providing a audio warning to the user, via a speaker of the vehicle in accordance with instructions provide by the processor, that the door cannot be opened to the requested opening position due to the object that is in a path of the door.

Also in an exemplary embodiment, the step of taking corrective action includes providing a haptic warning to the user, via vibration of a seat of the user via a haptic actuator coupled thereto in accordance with instructions provide by the processor, that the door cannot be opened to the requested opening position due to the object that is in a path of the door.

Also in an exemplary embodiment, the method further includes determining, via the processor using the radar sensor data and the input sensor data, whether the object would interfere with each of a plurality of potential opening positions for the door; and providing a color-coded display for the user of the vehicle on a display screen of the vehicle, in accordance with instructions provided by the processor, the color-coded display including the plurality of potential opening positions of the door, in which each particular opening position of the plurality of potential opening positions is depicted: in a first color if the object would not prevent opening of the door to the particular opening position, as determined via the processor based on the detection sensor data and input senor data; and in a second color if the object would prevent opening of the door to the particular opening position, as determined via the processor based on the detection sensor data and input senor data.

Also in an exemplary embodiment, the plurality of potential opening positions include: a standard opening position that includes a default opening position of the vehicle; a slight opening position that represents opening of the door less than the default opening position; and a maximum opening position that represents opening of the door more than the default opening position; the step of obtaining the input sensor data includes sensing, via the one or more input sensors, a scrolling by the user of a cursor of the color-coded display to a selected one of the standard opening position, slight opening position, or maximum opening position; the step of automatically opening the door includes; and the step of taking the corrective action includes: automatically opening the door to the requested opening position, in accordance with instructions provided by the processor to the one or more actuators of the vehicle and that are implemented via the one or more actuators, when it is determined by the processor that the user has selected, via the scrolling by the user of the cursor on the color-coded display, to an opening position depicted in the first color; and taking the corrective action, instead of opening the door to the requested opening position, in accordance with instructions provided by the processor, when it is determined by the processor that that the user has selected, via the scrolling by the user of the cursor on the color-coded display, an opening position depicted in the second color.

In another exemplary embodiment, a system for controlling opening a door of a vehicle is provided that includes: one or more detection sensors of the vehicle that are configured to obtain detection sensor data as to an object in proximity to the vehicle; one or more input sensors of the vehicle that are configured to obtain input sensor data as to a requested opening position for the door; and a processor that is coupled to the one or more detection sensors and to the one or more input sensors and that is configured to at least facilitate: determining, using the detection sensor data and the input sensor data, whether the object would interfere with the opening of the door to the requested opening position; automatically opening the door to the requested opening position, in accordance with instructions provided by the processor to one or more actuators of the vehicle and that are implemented via the one or more actuators, when it is determined by the processor that the object would not interfere with the opening of the door to the requested opening position; and taking corrective action, instead of opening the door to the requested opening position, in accordance with instructions provided by the processor, when it is determined by the processor that the object would interfere with the opening of the door to the requested opening position.

Also in an exemplary embodiment, the one or more detection sensors include one or more radar sensors of the vehicle that are configured to obtain radar sensor data as to the object; and the processor is further configured to at least facilitate determining, using the radar sensor data and the input sensor data, whether the object would interfere with the opening of the door to the requested opening position.

Also in an exemplary embodiment, the processor is further configured to at least facilitate taking the corrective action by providing a warning to a user of the vehicle, instead of automatically opening the door to the requested opening position, when it is determined by the processor that the object would interfere with the opening of the door to the requested opening position.

Also in an exemplary embodiment, the processor is further configured to at least facilitate taking the corrective action by providing a visual warning to the user, on a display screen of the vehicle in accordance with instructions provide by the processor, that the door cannot be opened to the requested opening position due to the object that is in a path of the door.

Also in an exemplary embodiment, the processor is further configured to at least facilitate taking the corrective action by providing a audio warning to the user, via a speaker of the vehicle in accordance with instructions provide by the processor, that the door cannot be opened to the requested opening position due to the object that is in a path of the door.

Also in an exemplary embodiment, the processor is further configured to at least facilitate taking the corrective action by providing a haptic warning to the user, via vibration of a seat of the user via a haptic actuator coupled thereto in accordance with instructions provide by the processor, that the door cannot be opened to the requested opening position due to the object that is in a path of the door.

Also in an exemplary embodiment, the processor is further configured to at least facilitate: determining, using the radar sensor data and the input sensor data, whether the object would interfere with each of a plurality of potential opening positions for the door; and providing a color-coded display for the user of the vehicle on a display screen of the vehicle, in accordance with instructions provided by the processor, the color-coded display including the plurality of potential opening positions of the door, in which each particular opening position of the plurality of potential opening positions is depicted: in a first color if the object would not prevent opening of the door to the particular opening position, as determined via the processor based on the detection sensor data and input senor data; and in a second color if the object would prevent opening of the door to the particular opening position, as determined via the processor based on the detection sensor data and input senor data.

Also in an exemplary embodiment, the first color is blue; and the second color is red.

Also in an exemplary embodiment, the plurality of potential opening positions include: a standard opening position that includes a default opening position of the vehicle; a slight opening position that represents opening of the door less than the default opening position; and a maximum opening position that represents opening of the door more than the default opening position; the one or more input sensors are further configured to obtain the input sensor data by sensing a scrolling by the user of a cursor of the color-coded display to a selected one of the standard opening position, slight opening position, or maximum opening position; and the processor is further configured to at least facilitate: automatically opening the door to the requested opening position, in accordance with instructions provided by the processor to the one or more actuators of the vehicle and that are implemented via the one or more actuators, when it is determined by the processor that the user has selected, via the scrolling by the user of the cursor on the color-coded display, an opening position depicted in the first color; and taking the corrective action, instead of opening the door to the requested opening position, in accordance with instructions provided by the processor, when it is determined by the processor that that the user has selected, via the scrolling by the user of the cursor on the color-coded display, to an opening position depicted in the second color.

In another exemplary embodiment, a vehicle is provided that includes a door, one or more actuators, one or more radar systems, o or more input sensors, and a processor. The one or more actuators are configured to move the door. The one or more radar sensors are configured to obtain radar sensor data as to an object in proximity to the vehicle. The one or more input sensors are configured to obtain input sensor data as to a requested opening position for the door. The processor is coupled to the one or more radar sensors and to the one or more input sensors, and is configured to at least facilitate: determining, using the radar sensor data and the input sensor data, whether the object would interfere with each of a plurality of potential opening positions; providing a color-coded display for a user of the vehicle on a display screen of the vehicle and from which the input sensor data is obtained via the one or more input sensors, in accordance with instructions provided by the processor, the color-coded display including the plurality of potential opening positions of the door, in which each particular opening position of the plurality of potential opening positions is depicted: in a first color if the object would not prevent opening of the door to the particular opening position, as determined via the processor based on the radar sensor data and input senor data; and in a second color if the object would prevent opening of the door to the particular opening position, as determined via the processor based on the radar sensor data and input senor data; automatically opening the door to the requested opening position, in accordance with instructions provided by the processor to the one or more actuators of the vehicle and that are implemented via the one or more actuators, when it is determined by the processor that the user has selected an opening position depicted in the first color; and taking corrective action by providing a warning to the user of the vehicle, instead of opening the door to the requested opening position, in accordance with instructions provided by the processor, when it is determined by the processor that the user has selected an opening position depicted in the second color.

Also in an exemplary embodiment, the plurality of potential opening positions include: a standard opening position that includes a default opening position of the vehicle; a slight opening position that represents opening of the door less than the default opening position; and a maximum opening position that represents opening of the door more than the default opening position; the one or more input sensors are further configured to obtain the input sensor data by sensing a scrolling by the user of a cursor of the color-coded display to a selected one of the standard opening position, slight opening position, or maximum opening position; and the processor is further configured to at least facilitate: automatically opening the door to the requested opening position, in accordance with instructions provided by the processor to the one or more actuators of the vehicle and that are implemented via the one or more actuators, when it is determined by the processor that the user has selected, via the scrolling by the user of the cursor on the color-coded display, to one of the standard opening position, slight opening position, or maximum opening position that is depicted in the first color; and taking the corrective action, instead of opening the door to the requested opening position, in accordance with instructions provided by the processor, when it is determined by the processor that that the user has selected, via the scrolling by the user of the cursor on the color-coded display, to one of the standard opening position, slight opening position, or maximum opening position that is depicted in the second color.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a plurality of doors in addition to a control system for automatically controlling the doors, including when an object is in proximity to the vehicle, in accordance with exemplary embodiments;

FIG. 2 is a flowchart of a process for automatically controlling doors of a vehicle, including when an object is in proximity to the vehicle, and that can be implemented in connection with the vehicle of FIG. 1, including the doors and control system thereof, in accordance with exemplary embodiments; and

FIGS. 3-8 provide illustrations of implementations of the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

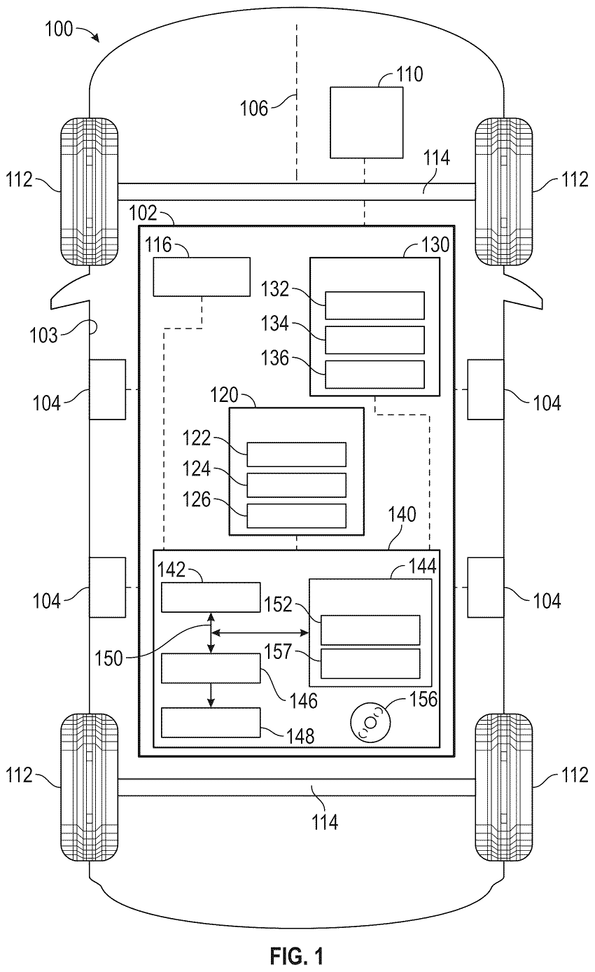

FIG. 1 illustrates a vehicle 100, according to an exemplary embodiment. As described in greater detail further below, the vehicle 100 includes a plurality of doors 104 and a control system 102 configured for automatically controlling the doors, including when an object is disposed in proximity to the vehicle 100, in accordance with exemplary embodiments.

In various embodiments, the vehicle 100 includes an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 103 that is arranged on a chassis 106. The body 103 substantially encloses other components of the vehicle 100. The body 103 and the chassis 106 may jointly form a frame. The vehicle 100 also includes a plurality of wheels 112. The wheels 112 are each rotationally coupled to the chassis 106 near a respective corner of the body 103 to facilitate movement of the vehicle 100. In one embodiment, the vehicle 100 includes four wheels 112, although this may vary in other embodiments (for example for trucks and certain other vehicles).

A drive system 110 is mounted on the chassis 106, and drives the wheels 112, for example via axles 114. In certain embodiments, the drive system 110 comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used.

In various embodiments, the doors 104 comprise power doors that are automatically controlled by the control system 102, including when a driver or other user of the vehicle 100 provides input for opening of one or more of the doors 104. In the depicted embodiment the vehicle 100 has four doors 104, for example including two front doors 104 (e.g., by a front row of seats of the vehicle 100) and two rear doors 104 (e.g., by one or more rear rows of seats of the vehicle 100). In certain embodiments, the number of doors 104 of the vehicle 100 may vary.

In certain embodiments, the vehicle 100 may also include one or more other types of opening members, instead of or in addition to the doors 104. In certain embodiments, the opening members may also include, in addition, to doors, one or more liftgates, hoods, tailgates, and/or one or more other types of opening members. Accordingly, as referenced throughout this Application, in various embodiments references to doors may similarly refer to liftgates, hoods, tailgates, and/or one or more other types of opening members.

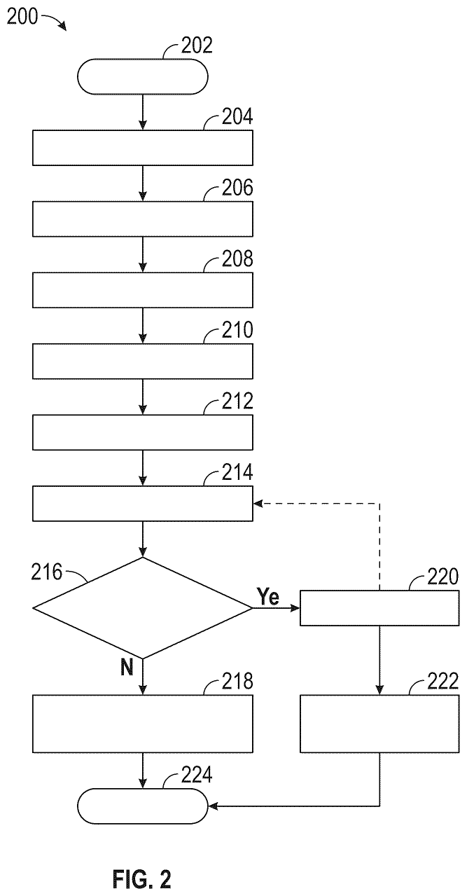

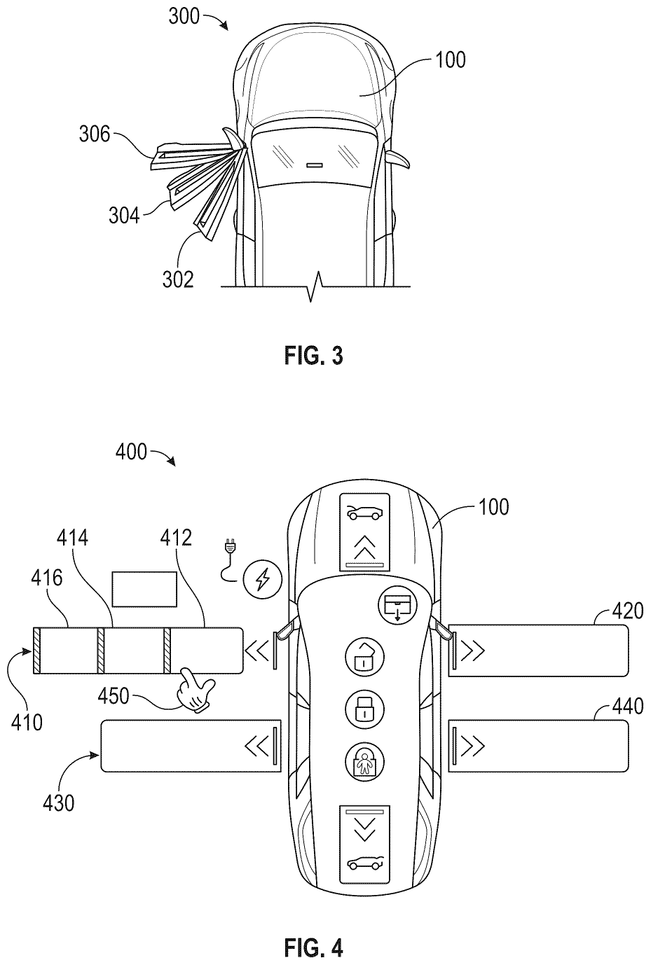

With continued reference to FIG. 1, in various embodiments the control system 102 is coupled to the doors 104 (or other opening members of the vehicle 100), and controls operation thereof, including in accordance with the process 200 of FIG. 2 and the implementations of FIGS. 3-8. In certain embodiments, the control system 102 may also be coupled to one or more other vehicle systems (e.g., the drive system 110, among others) and control operation thereof in whole or in part.

As depicted in FIG. 1, in various embodiments, the control system 102 includes one or more actuators 116, along with a sensor array 120, a display 130, and a controller 140, as described in greater detail below.

In various embodiments, the actuators 116 are each coupled to one or more of the doors 104 and to the controller 140. Specifically, in various embodiments, the actuators 116 receive instructions form the controller 140 for automatic movement of the doors 104, and implement the instructions to automatically open and close the doors 104 accordingly in accordance with the instructions.

In various embodiments, the sensor array 120 includes various sensors that obtain sensor data for use in controlling the automatic operation of the doors 104. In various embodiments, the sensor array 120 includes one or more detection sensors 122 and input sensors 124. Also in certain embodiments, the sensor array 120 may also include one or more other sensors 126.

In various embodiments, the detection sensors 122 detect any objects that may be disposed in proximity to the vehicle 100, including any objects that may impede with or contact one or more of the doors 104 as the doors 104 are opened or closed. In various embodiments, such an object may comprise a pole, tree, curb, building, traffic cone, person, animal, other vehicle, and/or any number of other different types of objects that could potentially impede or prevent one or more of the doors 104 from opening fully. In addition, in certain embodiments, the detection sensors 122 comprise one or more radar sensors that are mounted on the vehicle 100 and that are configured to detect objects that are outside of and in proximity to the vehicle 100. In certain embodiments, one or more other types of detection sensors 122 may also be utilized, such as one or more cameras, radar, sonar, Lidar, or the like.

Also in various embodiments, the input sensors 124 detect an input from one or more drivers or other users of the vehicle 100, including as to a user request to open or close one or more doors 104 of the vehicle 100. In certain embodiments, the input sensors 124 are part of a touch screen (e.g., as part of the display 130 discussed below). In one such embodiment, the one or more input sensors 124 detect a user's sliding motion that is representative of an extent to which the user wishes for the door 104 to be opened, including (1) a standard (or default) amount; (2) a slight or lesser amount (i.e., less than the standard amount); or (3) a maximum or greater amount (i.e., greater than the standard amount). In certain other embodiments, the input sensors 124 may also be coupled to or part of other input devices for the user, such as a button, switch, rotary knob, or the like, and/or a speaker for verbal commands, and so on. In certain embodiments, the input sensors 124 may comprise, by way of example, in one or more capacitive and/or touch-detecting sensors, among other possible types of input sensors 124.

In addition, in certain embodiments, the other sensors 126 may include one or more additional sensors that may pertain to the doors 104 and/or the controlling thereof, such as sensors that obtain sensor data as to a current opening state of the door 104, and/or a state of the drive system 110 and/or one or more components thereof, or the like.

In various embodiments, the display 130 provides information for a driver and/or other user of the vehicle 100, including with respect to control of the doors 104. In various embodiments, the display 130 provides information as to options for opening of the doors 104, including possible different amounts for which one or more of the doors 104 can be opened, and including a reference to any objects that may prevent or inhibit the opening of the doors 104 by certain amounts. In certain embodiments, the display 130 also includes an input device for receiving user inputs, including a request from a driver or other user of the vehicle 100 for opening one or more of the doors 104 by a predetermined amount or to a predetermined position. In certain embodiments, the display 130 may also provide information and/or receive user requests as to closing of the doors 104.

In various embodiments, the display 130 comprises a visual notification system 132 that includes a display screen for visual depiction of this information pertaining to the doors 104, and including a color-coded visual depiction of various options for opening the doors 104 and which options would be precluded by nearby objects. Also in various embodiments, the user inputs are also received via a touch panel feature of the display screen, including wherein the user can slide on the touch panel by varying amounts to request one of a plurality of different amounts for opening of the door 104 (e.g., a standard amount, a slight amount, and a maximum amount of opening). Finally, in certain embodiments, the display screen also provides a warning if the user requests that a particular door 104 to be opened by an amount that would be likely to contact an object. These implementations of the display 130 are described in greater detail further below in connection with the process 200 of FIG. 2 and the implementations of FIGS. 3-8.

Also in certain embodiments, the display 130 may also include an audio notification system 134. Specifically, in certain embodiments, the audio notification system 134 may include one or more speakers that provide audio information regarding the doors 104 (including information as to possible opening amounts, information as to objects in proximity thereto, and warnings when the user requests a door opening amount that would contact an object, such as described above) via the one or more speakers. In addition, in certain embodiments, the audio notification system 134 may also include one or more microphones for receiving user inputs, including requested amounts for opening the doors 104. In certain embodiments, the audio notification system 134 may be part of or coupled to a chime system of the vehicle 100. In certain other embodiments, the audio notification system 134 may instead be coupled to a radio system of the vehicle 100.

In addition, in certain embodiments, the display 130 may also include a haptic notification system 136. In various embodiments, the haptic notification system 136 is configured to provide a warning or other notification to a driver of the vehicle 100 in certain circumstances, such as when the driver has requested that a door 104 be amount by an amount that would be likely to contact one or more objects. In certain embodiments, the haptic notification system 136 provides such haptic warnings by causing a vibration of one or more seats, such as driver seat, of the vehicle 100. In certain embodiments, one or more other types of haptic notifications may also be provided.

In various embodiments, the controller 140 is coupled to the actuators 116, and to the sensor array 120 and the display 130. In certain embodiments, the controller 140 may also be coupled to one or more other vehicle systems, such as the drive system 110. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 controls the display 130, including the information with respect to the doors 104 that is provided on the display 130 for the driver or other user of the vehicle 100. In various embodiments, the controller 140 provides these and other functions in accordance with the steps of the process 200 of FIG. 2 and the implementations of FIGS. 3-8.

In various embodiments, the controller 140 (and, in certain embodiments, the control system 102 itself) is disposed within the body 103 of the vehicle 100. In one embodiment, the control system 102 is mounted on the chassis 106. In certain embodiments, the controller 140 and/or control system 102 and/or one or more components thereof may be disposed outside the body 103, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 of FIG. 2 and the implementations of FIGS. 3-8.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with stored values 157 (e.g., threshold values for the process 200 in various embodiments).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 discussed further below in connection with FIG. 2 and the implementations of FIGS. 3-8. In another exemplary embodiment, the program product may be directly stored in and/or otherwise accessed by the memory 144 and/or a disk (e.g., disk 156), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIG. 2 is a flowchart of a process 200 for controlling doors of a vehicle, including when an object is in proximity to the vehicle, in accordance with exemplary embodiments. Also in various embodiments, the process 200 can be implemented in connection with the vehicle 100 of FIG. 1, including the doors 104 and the control system 102 of FIG. 1. The process 200 is described below in connection with the flowchart as presented in FIG. 2 as well as the implementations that are depicted in FIGS. 3-8 and that are described in greater detail further below in connection therewith. In addition, it is noted that while the process 200 of FIG. 2 and implementations of FIGS. 3-8 are described in terms of doors 104, it will be appreciated that in various embodiments the process 200 of FIG. 2 and implementations of FIGS. 3-8 may be similarly implemented in connection with other types of opening members of the vehicle 100, such as one or more liftgates, hoods, tailgates, and/or one or more other types of opening members of the vehicle 100.

As depicted in FIG. 2, in various embodiments, the process 200 begins at step 202. In one embodiment, the process 200 begins when a vehicle drive or ignition cycle begins, for example when a driver enters the vehicle for operation of the vehicle. In one embodiment, the steps of the process 200 are performed continuously during operation of the vehicle.

In various embodiments, sensor data is collected (step 204). In various embodiments, sensor data is collected from the sensor array 120 of FIG. 1, including from the detection sensors 122 (e.g., radar sensors) and input sensors 124 of the vehicle 100. Specifically, in various embodiments, sensor data is obtained from the detection sensors 122 regarding any objects that may be in proximity to the vehicle 100. In certain embodiments, other sensor data may also be obtained (e.g., as to preliminary inputs form the user, and so on).

In various embodiments, objects are detected (step 206). In various embodiments, objects are detected that may be in a path of opening of the doors 104 of FIG. 1. In various embodiments, such objects are detected based on the sensor data of step 204, either directly from the detection sensors 122 and/or via the processor 142 based on the sensor data. Also in various embodiments distances from the objects to the doors 104 are likewise obtained based on the sensor data (step 208), either directly by the detection sensors 122 or via the processor 142 based on the sensor data.

In various embodiments, acceptable door opening ranges are determined (step 210). Specifically, in various embodiments, the processor 142 determines how far each of the doors 104 of the vehicle 100 can be opened without contacting an object. Also in various embodiments, the processor 142 similarly determines whether each door 104 of the vehicle 100 can be opened without contacting an object with respect to each of a plurality of possible opening positions of the door 104, including (1) a standard or default amount of opening; (2) a slight opening that is less than the standard opening; and (3) a full amount of opening (also referred to as a maximum opening) that is greater than the standard opening.

In various embodiments, an initial display is provided (step 212). Specifically, in various embodiments, an initial display is provided on a display screen of the visual notification system 132 of the display 130 of FIG. 1, in accordance with instructions provided by the processor 142, with respect to possible opening ranges for each of the doors 104 of the vehicle 100. Also in various embodiments, the initial display of step 212 includes a color-coded display that includes, for each door 104 of the vehicle 100, a visual indication of which opening ranges are permissible (i.e., clear) for the door 104 along with which opening ranges are not permissible (i.e., blocked by an object).

With reference to FIGS. 3 and 4, exemplary illustrations 300, 400 are provided, respectively, to the initial display of step 212 (along with preceding steps of the process 200 of FIG. 2) in a first situation in which no obstacles are present that would prevent full opening of the doors 104.

As shown in FIG. 3, in this particular situation of illustration 300, a particular door 104 at issue can open to either its slight opening position 302 (i.e., corresponding to a minimum opening position); standard opening position 304 (i.e., corresponding to a default opening position that is greater than the slight opening position 302), and maximum opening position 306 (i.e., corresponding to a full opening position that is greater than both the slight opening position 302 and the standard opening position 304), all without encountering any obstacles (i.e., as determined via steps 204-210).

In addition, as shown in FIG. 4, in this same particular situation in which no obstacles are present (also corresponding to illustration 400), exemplary initial notifications 410, 420, 430, and 440 are provided with respect to each of the different corresponding doors 104 of the vehicle 100, in accordance with exemplary embodiments. Also as shown in FIG. 1, in accordance with an exemplary embodiments, each of the initial notifications (and for example as shown in detail with respect to representative initial notification 410) includes separate opening position notifications 412, 414, and 416 with respect to different opening positions of the door 104. For example, in the depicted embodiment: (i) a first opening position notification 412 indicates whether the door 104 can open to the slight opening position 302 of FIG. 1 without contacting an object; (ii) a second opening position notification 414 indicates whether the door 104 can open to the standard opening position 304 of FIG. 1 without contacting an object; and (iii) a fourth opening position notification 414 indicates whether the door 104 can open to the maximum opening position 306 of FIG. 1 without contacting an object.

In various embodiments, each of the opening position notifications 412, 414, and 416 are color-coded to indicate whether the door 104 can be opened with to the respective opening positions 302, 304, and 306 without contacting an object. In one such embodiment, the opening position notifications 412, 414, and 416 are blue if the door 104 can be opened to the respective opening position, and are instead red if the door 104 cannot be opened to the respective opening position. Accordingly, in the situations in FIGS. 3 and 4 in which no objects are interfering with the opening of the door 104, each of the 412, 414, and 416 appear in the blue color in this embodiment.

Also as shown in FIG. 4, in an exemplary embodiment, the initial notification 410 also includes a prompt 450 (e.g., a cursor) for the driver or other user to select a requested opening position for the door 104. As depicted in FIG. 4, in an exemplary embodiment, the user can slide the prompt 450 (e.g., cursor) to the left or right to indicate a desired opening position for the door 104. For example: (i) if the user requests the door 104 to be opened to the slight opening position 302 of FIG. 3, then the user may slide the prompt 450 to the location of the first opening position notification 412; (ii) if the user requests the door 104 to be opened to the standard opening position 304 of FIG. 3, then the user may slide the prompt 450 to the location of the second opening position notification 414; and (iii) if the user requests the door 104 to be opened to the maximum opening position 306 of FIG. 3, then the user may slide the prompt 450 to the location of the third opening position notification 416.

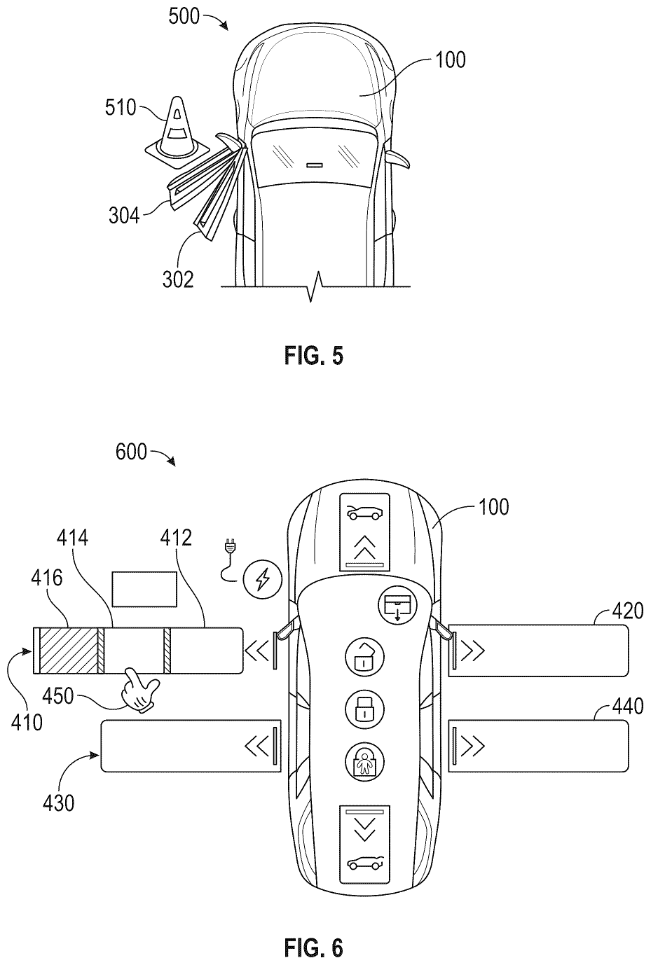

With reference next to FIGS. 5 and 6, exemplary illustrations 500, 600 are provided, respectively, to the initial display of step 212 (along with preceding steps of the process 200 of FIG. 2) in a first situation in which no obstacles are present that would prevent full opening of the doors 104.

As shown in FIG. 5, in this particular situation of illustration 600, a particular door 104 at issue can open to either its slight opening position 302 or standard opening position 304 without encountering any obstacles (i.e., as determined via steps 204-210). However, in this situation of FIG. 5, an object 510 is blocking the door 104 from opening fully (i.e., to its maximum opening position).

In addition, as shown in FIG. 6 in this same particular situation of FIG. 5, the separate opening position notifications 412, 414, and 416 are still depicted with respect to different opening positions of the door 104 (i.e., similar to FIG. 4). However, as shown in the illustration 600 of FIG. 6, in this particular situation opening position notification 416 is depicted in red, so as to indicate that the door 104 cannot fully open to its maximum opening position 306 (i.e., due to the object blocking the door 104's path). Accordingly, in various embodiments, the user is instructed to scroll the prompt 450 (i.e., cursor) only to opening position notifications 412 or 414 (which are depicted in blue) and not to opening position notification 416 (which is depicted in red).

While FIGS. 3-6 depict situations in which either (A) an object is not detected that would interfere with opening of the door 104 (i.e., FIGS. 3 and 4) or (B) an object is detected that would interfere with the fully open position (i.e., FIGS. 5 and 6), it will be appreciated that the process 200 can similarly be applied in situations in which (C) an object may also interfere with opening the door to the standard opening position 304 (in which case opening position notifications 414 and 416 would appear red, and the user may be directed to select only the opening position of opening position notification 412 for the door 104) or (D) an object may also interfere with opening the door to even the slight opening position 302 (in which case opening position notifications 412, 414, and 416 would appear red, and the user may be directed to not select any opening position of opening position notifications 414, 414, and/or 416 for the door 104, and to instead open a different door 104 or move the vehicle 100, or the like).

With reference back to FIG. 2, in various embodiments a user input is obtained (step 214). Specifically, in various embodiments, one or more input sensors 124 of FIG. 1 obtain input sensor data from the user's response to the initial display of step 212. For example, in certain embodiments, the input sensors 124 detect a user's sliding and/or placement of the prompt 450 (e.g., cursor) of FIG. 4 or 6 to one of the opening positions of opening position notifications 412, 414, or 416 with respect to the user's request for an opening positioning of the door 104 (e.g., to the slight opening position 302, the standard opening position 304, or the maximum opening position 306).

In various embodiments, a determination is made as to whether the user's request corresponds to an opening position of the door 104 that would cause potential contact with an object (step 216). Specifically, in various embodiments, during step 216 the processor 142 determines whether the door 104 would be likely to contact an object if opened to the position requested by the user via the user input.

In various embodiments, if it is determined in step 216 that the door 104 would not be likely to contact an object if opened to the position requested by the user via the input, then the door is opened to the full amount requested by the user (step 218). Specifically, during step 218, the processor 142 commands the actuators 116 to open the door 104 to the opening position requested by the user via the user inputs of step 214). Also in various embodiments, the one or more actuators 116 implement the instructions provided by the processor 142 in opening the door to the opening position requested by the user via the user inputs (e.g., to the slight opening position 302, the standard opening position 304, or the maximum opening position 306, whichever was requested by the user via the user inputs).

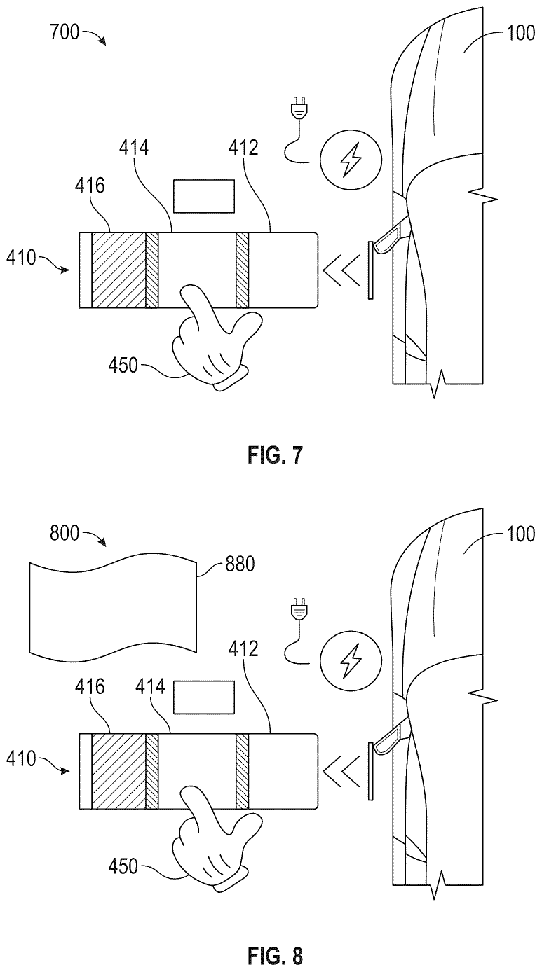

With reference to FIG. 7, an illustration 700 is provided with respect to this situation of step 218 (i.e., in which the door 104 would not be likely to contact an object if opened to the position requested by the user via the input) in accordance with an exemplary embodiment. As depicted in the illustration 700 of FIG. 7, in this situation the user has selected one of the permissible (i.e., blue) door displays of FIG. 6, namely by clicking on or pointing to opening position notification 414 of FIGS. 6 and 7 (i.e., corresponding to the standard opening position 304 of FIG. 5, which would not be prevented by the object 510 of FIG. 5).

Accordingly, with reference back to FIG. 2, in this example the door 104 is commanded to the requested standard opening position 304 in step 218 in this situation.

In various embodiments the process 200 then terminates at step 224.

Conversely, in various embodiments, if it is instead determined in step 216 that the door 104 would be likely to contact an object if opened to the position requested by the user via the input, then the process 200 proceeds to step 220. In various embodiments, during step 220, corrective action is provided. Specifically, in various embodiments, the processor 142 does not automatically open the door 104 to the requested opening position, and instead provides a warning for the user. In various embodiments, the processor 142 provides instructions to the display 130 to provide one or more warnings for the user that the selected opening position for the door 104 is not permitted (i.e., to the object). In various embodiments, the warning is then implemented via one or more components of the display 130.

In certain embodiments, as part of step 220, a visual warning is provided for the user on a display screen of the visual notification system 132 of the display 130 of FIG. 1, in accordance with instructions provided by the processor 142. In various embodiments, the warning informs the user that the selected opening position is not allowed, and requests that the user select a different opening position for the door 104.

With reference to FIG. 8, an illustration 800 is provided with respect to this situation of step 220 (i.e., in which the warning is provided because the door 104 would be likely to contact an object if opened to the position requested by the user via the input) in accordance with an exemplary embodiment. As depicted in the illustration 800 of FIG. 8, in this situation the user has selected an impermissible (i.e., red) door display of FIG. 6, namely by clicking on or pointing to the third opening position notification 416 of FIGS. 6 and 8 (i.e., corresponding to the maximum opening position 306, which would be prevented by the object 510 of FIG. 5). Accordingly, in various embodiments as depicted in FIG. 8, during step 220 a visual warning 880 is provided on the display screen (e.g., stating something along the lines of “Obstacle Detected: Door Open Limited to Standard”) in this scenario.

With reference back to FIG. 2, also in certain embodiments, additional warnings may also be provided in step 220. In certain embodiments, one or more audio warnings may be provided with a similar message by the audio notification system 134 of FIG. 1 (e.g., as part of a radio or chime module of the vehicle 100 in certain embodiments) in accordance with instructions provided by the processor. In addition, also in certain embodiments, one or more haptic warnings may be provided with a similar message by the haptic notification system 136 of FIG. 1 (e.g., via vibration of a user's seat in certain embodiments) in accordance with instructions provided by the processor.

In certain embodiments, following the warning of step 220, the process 200 may return to step 214, as new inputs are obtained from the user in view of the warning of step 220. In certain embodiments, the process then proceeds in a new iteration, with updated inputs of step 214 and an updated determination of step 216 in new iterations, and so on.

Alternatively, in certain other embodiments, following the warning of step 220, the door 104 may instead proceed to step 222. In certain embodiments, during step 222, the door 104 is automatically opened to a different position (less than that originally requested by the user) that is permissible without contacting the object (e.g., the standard opening position 304 in the example described above). In certain embodiments, this is performed by one or more actuators 116 of FIG. 1 in accordance with instructions provided by the processor 142. In certain embodiments, the process 200 then terminates at step 224.

Accordingly, methods, systems, and vehicles are provided for controlling opening a door of a vehicle. In various embodiments, radar sensor data is utilized by a processor in determining whether a detected object would impair a door from opening to one or more different opening positions. Also in various embodiments, a color-coded display is provided for the user with a plurality of possible opening locations for each door, with the different possible opening locations depicted in a specific color based on whether a detected object would impair the door's opening to that opening position. In addition, in various embodiments, corrective action is performed when the user selects an opening position that would be inhibited by the object. Specifically, in various embodiments, the door is not automatically opened to such a requested position, and instead a warning is provided for the user that indicates that an object is blocking the door's path to the requested location.

It will be appreciated that the systems, vehicles, and methods may vary from those depicted in the Figures and described herein. For example, the vehicle 100 of FIG. 1, including the doors 104 and the control system 102 and components thereof, may vary in different embodiments. It will similarly be appreciated that the steps of the process 200 may differ from that depicted in FIG. 2, and/or that various steps of the process 200 may occur concurrently and/or in a different order than that depicted in FIG. 2. It will similarly be appreciated that the implementations of FIGS. 3-8 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling opening an opening member of a vehicle, the method comprising:
obtaining detection sensor data, via one or more detection sensors of the vehicle, as to an object in proximity to the vehicle;
obtaining input sensor data, via one or more input sensors of the vehicle, as to a requested opening position for the opening member;
determining, via a processor of the vehicle using the detection sensor data and the input sensor data, whether the object would interfere with the opening of the opening member to the requested opening position;
automatically opening the opening member to the requested opening position, in accordance with instructions provided by the processor to one or more actuators of the vehicle and that are implemented via the one or more actuators, when it is determined by the processor that the object would not interfere with the opening of the opening member to the requested opening position; and
taking corrective action, instead of opening the opening member to the requested opening position, in accordance with instructions provided by the processor, when it is determined by the processor that the object would interfere with the opening of the opening member to the requested opening position.

2. The method of claim 1, wherein the opening member comprises a door of the vehicle.

3. The method of claim 2, wherein:
the step of obtaining the detection sensor data comprises obtaining radar sensor data, via one or more radar sensors of the vehicle, as to the object; and
the step of determining whether the object would interfere with the opening the door to the requested opening position comprises determining, via the processor using the radar sensor data and the input sensor data, whether the object would interfere with the opening of the door to the requested opening position.

4. The method of claim 2, wherein the step of taking corrective action comprises providing a warning to a user of the vehicle, instead of automatically opening the door to the requested opening position, when it is determined by the processor that the object would interfere with the opening of the door to the requested opening position.

5. The method of claim 4, wherein the step of taking corrective action comprises providing a visual warning to the user, on a display screen of the vehicle in accordance with instructions provide by the processor, that the door cannot be opened to the requested opening position due to the object that is in a path of the door.

6. The method of claim 4, wherein the step of taking corrective action comprises providing a audio warning to the user, via a speaker of the vehicle in accordance with instructions provide by the processor, that the door cannot be opened to the requested opening position due to the object that is in a path of the door.

7. The method of claim 4, wherein the step of taking corrective action comprises providing a haptic warning to the user, via vibration of a seat of the user via a haptic actuator coupled thereto in accordance with instructions provide by the processor, that the door cannot be opened to the requested opening position due to the object that is in a path of the door.

8. The method of claim 4, further comprising:
determining, via the processor using the radar sensor data and the input sensor data, whether the object would interfere with each of a plurality of potential opening positions for the door; and
providing a color-coded display for the user of the vehicle on a display screen of the vehicle, in accordance with instructions provided by the processor, the color-coded display including the plurality of potential opening positions of the door, in which each particular opening position of the plurality of potential opening positions is depicted:
in a first color if the object would not prevent opening of the door to the particular opening position, as determined via the processor based on the detection sensor data and input senor data; and
in a second color if the object would prevent opening of the door to the particular opening position, as determined via the processor based on the detection sensor data and input senor data.

9. The method of claim 8, wherein:
the plurality of potential opening positions include:
a standard opening position that comprises a default opening position of the vehicle;
a slight opening position that represents opening of the door less than the default opening position; and
a maximum opening position that represents opening of the door more than the default opening position;
the step of obtaining the input sensor data comprises sensing, via the one or more input sensors, a scrolling by the user of a cursor of the color-coded display to a selected one of the standard opening position, slight opening position, or maximum opening position;
the step of automatically opening the door comprises; and
the step of taking the corrective action comprises:
automatically opening the door to the requested opening position, in accordance with instructions provided by the processor to the one or more actuators of the vehicle and that are implemented via the one or more actuators, when it is determined by the processor that the user has selected, via the scrolling by the user of the cursor on the color-coded display, to an opening position depicted in the first color; and
taking the corrective action, instead of opening the door to the requested opening position, in accordance with instructions provided by the processor, when it is determined by the processor that that the user has selected, via the scrolling by the user of the cursor on the color-coded display, an opening position depicted in the second color.

10. A system for controlling opening a door of a vehicle, the system comprising:
one or more detection sensors of the vehicle that are configured to obtain detection sensor data as to an object in proximity to the vehicle;
one or more input sensors of the vehicle that are configured to obtain input sensor data as to a requested opening position for the door; and
a processor that is coupled to the one or more detection sensors and to the one or more input sensors and that is configured to at least facilitate:
determining, using the detection sensor data and the input sensor data, whether the object would interfere with the opening of the door to the requested opening position;
automatically opening the door to the requested opening position, in accordance with instructions provided by the processor to one or more actuators of the vehicle and that are implemented via the one or more actuators, when it is determined by the processor that the object would not interfere with the opening of the door to the requested opening position; and
taking corrective action, instead of opening the door to the requested opening position, in accordance with instructions provided by the processor, when it is determined by the processor that the object would interfere with the opening of the door to the requested opening position.

11. The system of claim 10, wherein:
the one or more detection sensors comprise one or more radar sensors of the vehicle that are configured to obtain radar sensor data as to the object; and
the processor is further configured to at least facilitate determining, using the radar sensor data and the input sensor data, whether the object would interfere with the opening of the door to the requested opening position.

12. The system of claim 10, wherein the processor is further configured to at least facilitate taking the corrective action by providing a warning to a user of the vehicle, instead of automatically opening the door to the requested opening position, when it is determined by the processor that the object would interfere with the opening of the door to the requested opening position.

13. The system of claim 12, wherein the processor is further configured to at least facilitate taking the corrective action by providing a visual warning to the user, on a display screen of the vehicle in accordance with instructions provide by the processor, that the door cannot be opened to the requested opening position due to the object that is in a path of the door.

14. The system of claim 12, wherein the processor is further configured to at least facilitate taking the corrective action by providing a audio warning to the user, via a speaker of the vehicle in accordance with instructions provide by the processor, that the door cannot be opened to the requested opening position due to the object that is in a path of the door.

15. The system of claim 12, wherein the processor is further configured to at least facilitate taking the corrective action by providing a haptic warning to the user, via vibration of a seat of the user via a haptic actuator coupled thereto in accordance with instructions provide by the processor, that the door cannot be opened to the requested opening position due to the object that is in a path of the door.

16. The system of claim 12, wherein the processor is further configured to at least facilitate:
determining, using the radar sensor data and the input sensor data, whether the object would interfere with each of a plurality of potential opening positions for the door; and
providing a color-coded display for the user of the vehicle on a display screen of the vehicle, in accordance with instructions provided by the processor, the color-coded display including the plurality of potential opening positions of the door, in which each particular opening position of the plurality of potential opening positions is depicted:
in a first color if the object would not prevent opening of the door to the particular opening position, as determined via the processor based on the detection sensor data and input senor data; and
in a second color if the object would prevent opening of the door to the particular opening position, as determined via the processor based on the detection sensor data and input senor data.

17. The system of claim 16, wherein:
the first color is blue; and
the second color is red.

18. The system of claim 16, wherein:
the plurality of potential opening positions include:
a standard opening position that comprises a default opening position of the vehicle;
a slight opening position that represents opening of the door less than the default opening position; and
a maximum opening position that represents opening of the door more than the default opening position;
the one or more input sensors are further configured to obtain the input sensor data by sensing a scrolling by the user of a cursor of the color-coded display to a selected one of the standard opening position, slight opening position, or maximum opening position; and
the processor is further configured to at least facilitate:
automatically opening the door to the requested opening position, in accordance with instructions provided by the processor to the one or more actuators of the vehicle and that are implemented via the one or more actuators, when it is determined by the processor that the user has selected, via the scrolling by the user of the cursor on the color-coded display, an opening position depicted in the first color; and
taking the corrective action, instead of opening the door to the requested opening position, in accordance with instructions provided by the processor, when it is determined by the processor that that the user has selected, via the scrolling by the user of the cursor on the color-coded display, to an opening position depicted in the second color.

19. A vehicle comprising:
a door;
one or more actuators configured to move the door;
one or more radar sensors configured to obtain radar sensor data as to an object in proximity to the vehicle;
one or more input sensors configured to obtain input sensor data as to a requested opening position for the door; and
a processor that is coupled to the one or more radar sensors and to the one or more input sensors and that is configured to at least facilitate:
determining, using the radar sensor data and the input sensor data, whether the object would interfere with each of a plurality of potential opening positions;
providing a color-coded display for a user of the vehicle on a display screen of the vehicle and from which the input sensor data is obtained via the one or more input sensors, in accordance with instructions provided by the processor, the color-coded display including the plurality of potential opening positions of the door, in which each particular opening position of the plurality of potential opening positions is depicted:
in a first color if the object would not prevent opening of the door to the particular opening position, as determined via the processor based on the radar sensor data and input senor data; and
in a second color if the object would prevent opening of the door to the particular opening position, as determined via the processor based on the radar sensor data and input senor data;
automatically opening the door to the requested opening position, in accordance with instructions provided by the processor to the one or more actuators of the vehicle and that are implemented via the one or more actuators, when it is determined by the processor that the user has selected an opening position depicted in the first color; and
taking corrective action by providing a warning to the user of the vehicle, instead of opening the door to the requested opening position, in accordance with instructions provided by the processor, when it is determined by the processor that the user has selected an opening position depicted in the second color.

20. The vehicle of claim 19, wherein:
the plurality of potential opening positions include:
a standard opening position that comprises a default opening position of the vehicle;
a slight opening position that represents opening of the door less than the default opening position; and
a maximum opening position that represents opening of the door more than the default opening position;
the one or more input sensors are further configured to obtain the input sensor data by sensing a scrolling by the user of a cursor of the color-coded display to a selected one of the standard opening position, slight opening position, or maximum opening position; and
the processor is further configured to at least facilitate:
automatically opening the door to the requested opening position, in accordance with instructions provided by the processor to the one or more actuators of the vehicle and that are implemented via the one or more actuators, when it is determined by the processor that the user has selected, via the scrolling by the user of the cursor on the color-coded display, to one of the standard opening position, slight opening position, or maximum opening position that is depicted in the first color; and
taking the corrective action, instead of opening the door to the requested opening position, in accordance with instructions provided by the processor, when it is determined by the processor that that the user has selected, via the scrolling by the user of the cursor on the color-coded display, to one of the standard opening position, slight opening position, or maximum opening position that is depicted in the second color.
